(19) United States
(12) Patent Application Publication
(10) Pub. No.: US 2021/0339429 A1
(43) Pub. Date: Nov. 4, 2021

(54) METHOD OF MANUFACTURING GRAPHENE POLYESTER CHIPS AND GRAPHENE DIAPHRAGM

(71) Applicants: Wei-Lin TSENG, Taipei City (TW); Amazing Cool Technology Corp, Taipei City (TW)

(72) Inventors: Wei-Lin TSENG, Taipei City (TW); Yang-Ming SHIH, Taipei City (TW); Chia-Lang CHAN, Taipei City (TW); Chia-Ming HSU, Taipei City (TW)

(21) Appl. No.: 16/861,481

(22) Filed: Apr. 29, 2020

(51) Int. Cl. B29B 9/06

(52) U.S. Cl. CPC B29B 9/06; B29K 2067/003

(57) ABSTRACT

A method of manufacturing graphene polyester chips including steps of: melt-mixing a polymer material and graphene powder having a mass fraction ≤2 wt %, and melt-mixing a tackifier with a mass fraction between 1 wt % and 3 wt %, a toughener with a mass fraction between 1 wt % and 3 wt %, and a dispersant with a mass fraction between 1 wt % and 4 wt % sequentially. Finally, a molten raw material is made into a plurality of graphene polyester chips each in form of short cylindrical particle. The present disclosure further includes a method of manufacturing graphene diaphragm.

### BACKGROUND

### Technical Field

The present disclosure relates to a method of manufacturing polyester chips and diaphragm, and more particularly to a method of manufacturing graphene polyester chips and graphene diaphragm both include graphene powder.

### Description of Related Art

The statements in this section merely provide background information related to the present disclosure and do not necessarily constitute prior art.

At present, the general plastic film on market has limited application fields due to insufficient rigidity, and the rigidity or other physical properties of the plastic film need to be additionally enhanced according to different requirements during application. For the application field of earphone or diaphragm of speaker, because of the rigidity of the general plastic film is generally insufficient in the prior art, it is usually necessary to first support the shape of the earphone or speaker with a paper or a plastic framework, and then coating a special film on surface of the paper or the plastic framework to increase its rigidity. However, due to the difference in the material properties or elasticity between the special film coated and the plastic film, stretching after coating will cause the deformation of the special film and the plastic film in various parts to be inconsistent, afterward the film quality of the diaphragm is not uniform and affects the quality of a final product of the diaphragm. In general, the special film can only be applied after the plastic film has formed. The combination of the aforementioned plastic framework and the coating process of the special film are difficult and the process steps are complicated, so it is difficult to reduce the overall manufacturing cost of the diaphragm.

Therefore, how to design a method of manufacturing graphene polyester chips and graphene diaphragm, in particular to solve the technical problems such as the process is difficult, the process steps are complicated, the film quality is uneven, and the manufacturing cost is difficult to reduce in the prior art, is an important subject studied by the inventor of the present disclosure.

### SUMMARY

One of the purposes of the present disclosure is to provide a method of manufacturing graphene polyester chips, the method can solve the technical problems such as the process is difficult, the process steps are complicated, the film quality is uneven, and the manufacturing cost is difficult to reduce in the prior art. To achieve a purpose of easy low-cost manufacturing.

In order to achieve the one of the purposes, the method of manufacturing graphene polyester chips includes steps of: Melt-mixing a polymer material and graphene powder having a mass fraction ≤2 wt %, and made into a plurality of graphene masterbatches each in form of short cylindrical particle. Melt-mixing a tackifier with a mass fraction between 1 wt % and 3 wt %, a toughener with a mass fraction between 1 wt % and 3 wt %, and a dispersant with a mass fraction between 1 wt % and 4 wt % sequentially into the plurality of graphene masterbatches. And madding a molten raw material into a plurality of graphene polyester chips each in form of short cylindrical particle, the molten raw material melt-mixing the plurality of graphene masterbatches, the tackifier, the toughener and the dispersant.

Further, a concentration of the graphene powder in the molten raw material is between 100 ppm and 5000 ppm.

Further, the tackifier includes at least one of methylcellulose (MC), carboxymethyl cellulose (CMC), hydroxyethyl cellulose (HEC), hydroxypropyl methyl cellulose (HPMC), acrylic acid (AA), maleic acid or maleic anhydride (MA), methacrylic acid (MAA), acrylate, phenylethene, N, N-methylene bis-acrylamide, 2-propenoic acid, butanediyl ester, diallyl phthalate, polyurethane (PU), and polyoxyethylene.

Further, the toughener includes at least one of polyurethanes, phenylethenes, polyolefins, polyesters, syndiotactic 1,2-poly butadiene, polyamides, and phthalates.

Further, the polymer material includes at least one of polyacrylonitrile (PAN), polycarbonate (PC), polypropylene (PP), polyethylene terephthalate (PET), polyamide (PA), nylon (Nylon), polyphenylethene (PS), polymethylmethacrylic acid (PMMA) and polylactic acid (PLA).

Further, a sum of the tackifier, the toughener and the dispersant accounts for less than 10 wt % of the molten raw material.

Further, an intrinsic viscosity of the plurality of graphene masterbatches is greater than 1 dl/g.

Another one of the purposes of the present disclosure is to provide a method of manufacturing graphene diaphragm, the method can solve the technical problems such as the process is difficult, the process steps are complicated, the film quality is uneven, and the manufacturing cost is difficult to reduce in the prior art. To achieve a purpose of easy low-cost manufacturing.

In order to achieve the another one of the purposes, the method of manufacturing graphene diaphragm includes steps of: Melting the plurality of graphene polyester chips described above. And biaxially stretching the plurality of graphene polyester chips melted by a biaxial stretching machine to form a graphene diaphragm. The polymer material includes polyethylene terephthalate (PET).

Further, a thickness of the graphene diaphragm is between 10 micrometers and 25 micrometers.

More another one of the purposes of the present disclosure is to provide a method of manufacturing graphene diaphragm, the method can solve the technical problems such as the process is difficult, the process steps are complicated, the film quality is uneven, and the manufacturing cost is difficult to reduce in the prior art. To achieve a purpose of easy low-cost manufacturing.

In order to achieve the more another one of the purposes, the method of manufacturing graphene diaphragm includes steps of: Melting the plurality of graphene polyester chips described above. And melting the plurality of graphene polyester chips, and radially stretching the plurality of graphene polyester chips melted by an injection molding machine to form a graphene diaphragm. The polymer material includes polypropylene (PP).

When using the method for manufacturing graphene polyester chips and graphene diaphragm of the present disclosure, since the graphene powder used in first step of the present disclosure only accounts for the mass fraction ≤2 wt %. For this reason, the original material properties of polymer materials will not be completely changed by adding graphene powder. In field of materials science, graphene has excellent mechanical properties, and graphene has high rigidity, high thermal conductivity, and high electron mobility are also ideal for polymeric materials. As long as a small amount of graphene can enhance the physical properties of polymer materials characteristic. However, for powdered materials, the Van der Waals force must still be overcome. Especially for graphene, the crystal structure of graphite is formed by stacking layers of monoatomic graphite sheets (i.e., called as graphene), and the monoatomic graphite sheets are connected to each other according to the Van der Waals force. However, in the process of modifying the polymer material using graphene, the molecular chain of the polymer material is easily affected by the Van der Waals force between each of the stacking layers of monoatomic graphite sheets and cannot form a uniform and stable bond. Eventually, the melt-mixing of graphene and polymer materials may be uneven, which may affect the uniformity and quality of the subsequent diaphragm formation. For this reason, in second step of the present disclosure, the thickener, the toughener, and the dispersant are sequentially melt-mixed in the plurality of graphene masterbatches, and such order is meaningful. First of all, the tackifier may be a material containing a phenolic hydroxyl group, a methylol group, a carboxyl group, an ester bond, an ether bond, etc. that easily generates a hydrogen bond network structure with polymer material such as resin or rubber. The tackifier can increase the melt flow index (MI) and make the material homolytic cleavage during the subsequent degradation process (e.g., melting). Afterward, the addition of toughener can change the intrinsic viscosity (IV) of the material, which can improve the elongation and shock resistance of the diaphragm. The intrinsic viscosity (IV) can be adjusted depending on the subsequent processing of the material (e.g., injection molding, casting, calendering, etc.). Finally, adding the dispersant can prevent the agglomeration or sedimentation of molecules of the material, which can make the physical properties of the material more uniform throughout, and can obtain graphene polyester chips and graphene diaphragm with uniform physical properties in the subsequent degradation process.

For this reason, the method of manufacturing graphene polyester chips can solve the technical problems such as the process is difficult, the process steps are complicated, the film quality is uneven, and the manufacturing cost is difficult to reduce in the prior art. To achieve the purpose of easy low-cost manufacturing.

In order to further understand the techniques, means, and effects of the present disclosure for achieving the intended purpose. Please refer to the following detailed description and drawings of the present disclosure. The drawings are provided for reference and description only, and are not intended to limit the present disclosure.

### BRIEF DESCRIPTION OF DRAWINGS

FIG. 1 is a flowchart of a method of manufacturing graphene polyester chips of the present disclosure.

FIG. 2 to FIG. 4 are flowcharts of an embodiment of the method of manufacturing graphene polyester chips of the present disclosure.

FIG. 5 and FIG. 6 are flowcharts of another embodiment of the method of manufacturing graphene polyester chips of the present disclosure.

### DETAILED DESCRIPTION

The embodiments of the present disclosure are described by way of specific examples, and those skilled in the art can readily appreciate the other advantages and functions of the present disclosure. The present disclosure may be embodied or applied in various other specific embodiments, and various modifications and changes can be made without departing from the spirit and scope of the present disclosure.

It should be understood that the structures, the proportions, the sizes, the number of components, and the like in the drawings are only used to cope with the contents disclosed in the specification for understanding and reading by those skilled in the art, and it is not intended to limit the conditions that can be implemented in the present disclosure, and thus is not technically significant. Any modification of the structure, the change of the proportional relationship, or the adjustment of the size, should be within the scope of the technical contents disclosed by the present disclosure without affecting the effects and the achievable effects of the present disclosure.

The technical content and detailed description of the present disclosure will be described below in conjunction with the drawings.

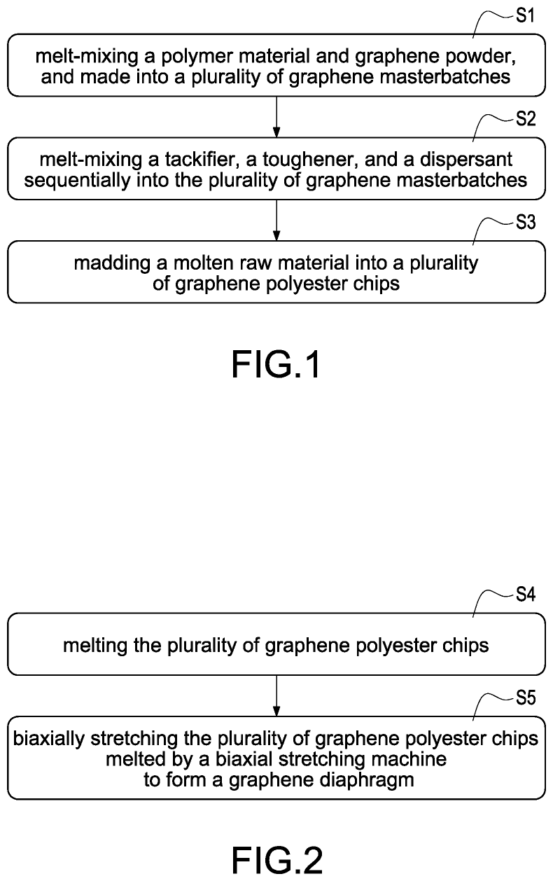

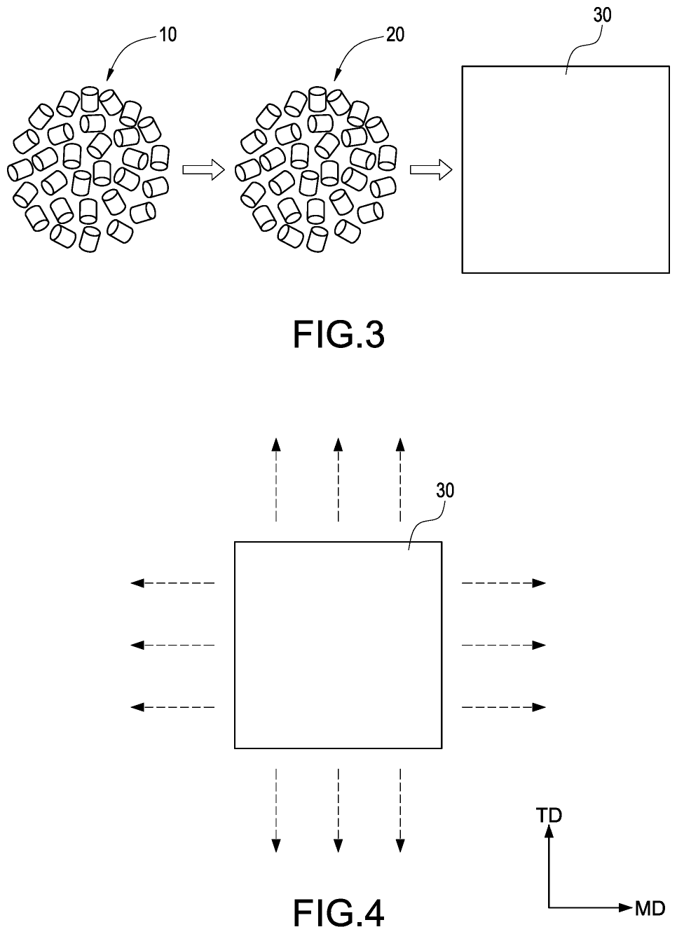

Please refer to FIG. 1 to FIG. 3. FIG. 1 is a flowchart of a method of manufacturing graphene polyester chips of the present disclosure. FIG. 2 and FIG. 3 are flowcharts of an embodiment of the method of manufacturing graphene polyester chips of the present disclosure.

In the embodiment of the present disclosure, the method of manufacturing graphene polyester chips 20 includes the following three steps: In first step, melt-mixing a polymer material and graphene powder having a mass fraction ≤2 wt %, and made into a plurality of graphene masterbatches 10 each in form of short cylindrical particle, as shown in step S1 of FIG. 1, and FIG. 3. Further, the graphene powder may include a plurality of graphene nanoplatelets (not shown), and more than 95% of the plurality of graphene nanoplatelets have a maximum plate diameter that is less than 45 micrometers (μm). In the first embodiment of the present disclosure, the polymer material includes at least one of polyacrylonitrile (PAN), polycarbonate (PC), polypropylene (PP), polyethylene terephthalate (PET), polyamide (PA), nylon (Nylon), polyphenylethene (PS), polymethylmethacrylic acid (PMMA) and polylactic acid (or called as polylactide, PLA). For subsequent processing and degradation, the intrinsic viscosity (IV) of the graphene masterbatch 10 must be maintained within a certain range greater than 1 dl/g. For example, a single-shot injection process requires the intrinsic viscosity (IV) of the graphene masterbatch 10 less than 0.85 dl/g. For another example, a continuous extrusion casting process requires the intrinsic viscosity (IV) of the graphene masterbatch 10 less than 0.7 dl/g to form a sheet, film or sheet.

In second step, melt-mixing a tackifier with a mass fraction between 1 wt % and 3 wt %, a toughener with a mass fraction between 1 wt % and 3 wt %, and a dispersant with a mass fraction between 1 wt % and 4 wt % sequentially into the plurality of graphene masterbatches 10. The sequence shown in step S2 of FIG. 1 is meaningful. First of all, the tackifier may be a material containing a phenolic hydroxyl group, a methylol group, a carboxyl group, an ester bond, an ether bond, etc. that easily generates a hydrogen bond network structure with polymer material such as resin or rubber. The tackifier can increase the melt flow index (MI) and make the material homolytic cleavage during the subsequent degradation process (e.g., melting). In the embodiments of the present disclosure, the tackifier includes at least one of methylcellulose (MC), carboxymethyl cellulose (CMC), hydroxyethyl cellulose (HEC), hydroxypropyl methyl cellulose (HPMC), acrylic acid (AA), maleic acid or maleic anhydride (MA), methacrylic acid (MAA), acrylate, phenylethene, N, N-methylene bis-acrylamide, 2-propenoic acid, butanediyl ester, diallyl phthalate, polyurethane (PU), and polyoxyethylene.

Afterward, the addition of toughener can change the intrinsic viscosity (IV) of the material, which can further improve the elongation and shock resistance of the diaphragm. The intrinsic viscosity (IV) can be adjusted depending on the subsequent processing of the material (e.g., injection molding, casting, calendering, etc.). In the embodiments of the present disclosure, the toughener includes at least one of polyurethanes, phenylethenes, polyolefins, polyesters, syndiotactic 1,2-poly butadiene, polyamides, and phthalates.

Finally, adding the dispersant can prevent the agglomeration or sedimentation of molecules of the material, which can make the physical properties of the material more uniform throughout, and can obtain graphene polyester chips 20 and graphene diaphragm with uniform physical properties in the subsequent degradation process. In the embodiment of the present disclosure, the graphene diaphragm can be a biaxially-oriented polyethylene terephthalate film (BOPET film) or an arc-shaped PP film. The BOPET film has a characteristic of high mechanical strength, high rigidity, high transparency and high surface gloss. In the embodiments of the present disclosure, a sum of the tackifier, the toughener and the dispersant accounts for less than 10 wt % of a molten raw material.

In third step, madding the molten raw material into a plurality of graphene polyester chips 20 each in form of short cylindrical particle, the molten raw material melt-mixing the plurality of graphene masterbatches 10, the tackifier, the toughener and the dispersant, as shown in step S3 of FIG. 1, and FIG. 3. Further, a concentration of the graphene powder in the molten raw material is between 100 ppm and 5000 ppm.

For the manufacturer of the diaphragm, the graphene polyester chips 20 as described above may be selected for further processing. As shown in FIG. 2 and FIG. 3, melting the plurality of graphene polyester chips 20 (step S4), and biaxially stretching the plurality of graphene polyester chips 20 melted by a biaxial stretching machine (not shown) to form a graphene diaphragm (step S5). Further, when the polymer material selected at this time is polyethylene terephthalate (PET), the graphene diaphragm can be made into a BOPET film 30, thereby achieving a purpose changing the physical properties of the diaphragm by adding graphene evenly. For example, it can increase the tensile strength and impact resistance, cold resistance, heat resistance, puncture resistance and wear resistance, and can be applied to the fields of speakers or headphones. As shown in FIG. 4, the BOPET film 30 can be extended in both directions along the machine direction (MD) and the vertical direction (TD), and subjected to appropriate cooling, heat treatment or surface processing (such as coating slurry or plasma treatment, etc.) to complete the entire process. Further, a thickness of the graphene diaphragm is between 10 micrometers (μm) and 25 micrometers (μm).

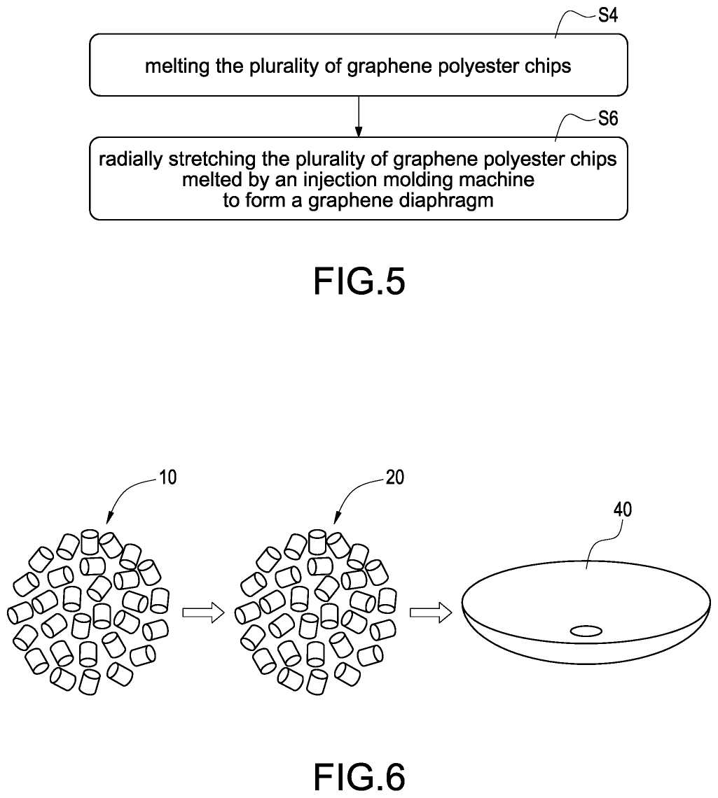

FIG. 5 and FIG. 6 are flowcharts of another embodiment of the method of manufacturing graphene polyester chips of the present disclosure. This embodiment is almost the same as the previous embodiment, except that after melting the plurality of graphene polyester chips 20 (step S4), and radially stretching the plurality of graphene polyester chips 20 melted by an injection molding machine (not shown) to form a graphene diaphragm (step S6). Further, when the polymer material selected at this time is polypropylene (PP), the graphene diaphragm can be made into a PP film 40. In this embodiment, the PP film 40 can be used as a diaphragm of car horn, but the application of the present disclosure is not limited thereto.

When using the method for manufacturing graphene polyester chips 20 and graphene diaphragm of the present disclosure, since the graphene powder used in first step of the present disclosure only accounts for the mass fraction ≤2 wt %. For this reason, the original material properties of polymer materials will not be completely changed by adding graphene powder. In field of materials science, graphene has excellent mechanical properties, and graphene has high rigidity, high thermal conductivity, and high electron mobility are also ideal for polymeric materials. As long as a small amount of graphene can enhance the physical properties of polymer materials characteristic. However, for powdered materials, the Van der Waals force must still be overcome. Especially for graphene, the crystal structure of graphite is formed by stacking layers of monoatomic graphite sheets (i.e., called as graphene), and the monoatomic graphite sheets are connected to each other according to the Van der Waals force. However, in the process of modifying the polymer material using graphene, the molecular chain of the polymer material is easily affected by the Van der Waals force between each of the stacking layers of monoatomic graphite sheets and cannot form a uniform and stable bond. Eventually, the melt-mixing of graphene and polymer materials may be uneven, which may affect the uniformity and quality of the subsequent diaphragm formation. For this reason, in second step of the present disclosure, the thickener, the toughener, and the dispersant are sequentially melt-mixed in the plurality of graphene masterbatches 10, and such order is meaningful. First of all, the tackifier may be a material containing a phenolic hydroxyl group, a methylol group, a carboxyl group, an ester bond, an ether bond, etc. that easily generates a hydrogen bond network structure with polymer material such as resin or rubber. The tackifier can increase the melt flow index (MI) and make the material homolytic cleavage during the subsequent degradation process (e.g., melting). Afterward, the addition of toughener can change the intrinsic viscosity (IV) of the material, which can improve the elongation and shock resistance of the diaphragm. The intrinsic viscosity (IV) can be adjusted depending on the subsequent processing of the material (e.g., injection molding, casting, calendering, etc.). Finally, adding the dispersant can prevent the agglomeration or sedimentation of molecules of the material, which can make the physical properties of the material more uniform throughout, and can obtain graphene polyester chips 20 and graphene diaphragm with uniform physical properties in the subsequent degradation process.

For this reason, the method of manufacturing graphene polyester chips 20 can solve the technical problems such as the process is difficult, the process steps are complicated, the film quality is uneven, and the manufacturing cost is difficult to reduce in the prior art, thereby achieving the purpose of easy low-cost manufacturing.

In addition, graphene has different reflectance for infrared (IR) and ultraviolet (UV) rays when stacked in different layers. In this embodiment, an average number of 2 to 5 layers is preferred. The addition of graphene powder with a concentration of 100 ppm to 5000 ppm in the molten raw material can increase the reflectivity to IR and UV rays, and can be used for heat insulation. The graphene diaphragm can be used as thermal insulating paper with high light transmittance and good heat insulation efficiency. Furthermore, graphene has high electron mobility characteristics and can also be used as an electrode separator for lithium batteries.

The above is only a detailed description and drawings of the preferred embodiments of the present disclosure, but the features of the present disclosure are not limited thereto, and are not intended to limit the present disclosure. All the scope of the present disclosure shall be subject to the scope of the following claims. The embodiments of the spirit of the present disclosure and its similar variations are intended to be included in the scope of the present disclosure. Any variation or modification that can be easily conceived by those skilled in the art in the field of the present disclosure can be covered by the following claims.

What is claimed is:

1. A method of manufacturing graphene polyester chips, comprising steps of:
melt-mixing a polymer material and graphene powder having a mass fraction ≤2 wt %, and made into a plurality of graphene masterbatches each in form of short cylindrical particle,
melt-mixing a tackifier with a mass fraction between 1 wt % and 3 wt %, a toughener with a mass fraction between 1 wt % and 3 wt %, and a dispersant with a mass fraction between 1 wt % and 4 wt % sequentially into the plurality of graphene masterbatches, and
madding a molten raw material into a plurality of graphene polyester chips each in form of short cylindrical particle, the molten raw material melt-mixing the plurality of graphene masterbatches, the tackifier, the toughener and the dispersant.

2. The method of manufacturing graphene polyester chips in claim 1, wherein a concentration of the graphene powder in the molten raw material is between 100 ppm and 5000 ppm.

3. The method of manufacturing graphene polyester chips in claim 1, wherein the tackifier includes at least one of methylcellulose (MC), carboxymethyl cellulose (CMC), hydroxyethyl cellulose (HEC), hydroxypropyl methyl cellulose (HPMC), acrylic acid (AA), maleic acid or maleic anhydride (MA), methacrylic acid (MAA), acrylate, phenylethene, N, N-methylene bis-acrylamide, 2-propenoic acid, butanediyl ester, diallyl phthalate, polyurethane (PU), and poly oxyethylene.

4. The method of manufacturing graphene polyester chips in claim 1, wherein the toughener includes at least one of polyurethanes, phenylethenes, polyolefins, polyesters, syndiotactic 1,2-poly butadiene, polyamides, and phthalates.

5. The method of manufacturing graphene polyester chips in claim 1, wherein the polymer material includes at least one of polyacrylonitrile (PAN), polycarbonate (PC), polypropylene (PP), polyethylene terephthalate (PET), polyamide (PA), nylon (Nylon), polyphenylethene (PS), polymethylmethacrylic acid (PMMA) and polylactic acid (PLA).

6. The method of manufacturing graphene polyester chips in claim 1, wherein a sum of the tackifier, the toughener and the dispersant accounts for less than 10 wt % of the molten raw material.

7. The method of manufacturing graphene polyester chips in claim 1, wherein an intrinsic viscosity of the plurality of graphene masterbatches is greater than 1 dl/g.

8. A method of manufacturing graphene diaphragm, comprising steps of:
melt-mixing a polymer material and a graphene powder having a mass fraction ≤2 wt %, and made into a plurality of graphene masterbatches each in form of short cylindrical particles,
melt-mixing a tackifier with a mass fraction between 1 wt % and 3 wt %, a toughener with a mass fraction between 1 wt % and 3 wt %, and a dispersant with a mass fraction between 1 wt % and 4 wt % sequentially into the plurality of graphene masterbatches,
madding a molten raw material into a plurality of graphene polyester chips each in form of short cylindrical particles, the molten raw material melt-mixing the plurality of graphene masterbatches, the tackifier, the toughener and the dispersant, and
melting the plurality of graphene polyester chips, and biaxially stretching the plurality of graphene polyester chips melted by a biaxial stretching machine to form a graphene diaphragm,
wherein the polymer material includes polyethylene terephthalate (PET).

9. The method of manufacturing graphene diaphragm in claim 8, wherein a thickness of the graphene diaphragm is between 10 micrometers and 25 micrometers.

10. A method of manufacturing graphene diaphragm, comprising steps of:
melt-mixing a polymer material and a graphene powder having a mass fraction ≤2 wt %, and made into a plurality of graphene masterbatches each in form of short cylindrical particles,
melt-mixing a tackifier with a mass fraction between 1 wt % and 3 wt %, a toughener with a mass fraction between 1 wt % and 3 wt %, and a dispersant with a mass fraction between 1 wt % and 4 wt % sequentially into the plurality of graphene masterbatches,
madding a molten raw material into a plurality of graphene polyester chips each in form of short cylindrical particles, the molten raw material melt-mixing the plurality of graphene masterbatches, the tackifier, the toughener and the dispersant, and
melting the plurality of graphene polyester chips, and radially stretching the plurality of graphene polyester chips melted by an injection molding machine to form a graphene diaphragm,
wherein the polymer material includes polypropylene (PP).
